(19) United States
(12) Patent Application Publication
(10) Pub. No.: US 2008/0105366 A1
(43) Pub. Date: May 8, 2008

(54) METHOD FOR PRODUCING PLASTIC PRODUCTS WITH REINFORCED HEAT SEALED JOINTS

(75) Inventor: Cheng-Chung WANG, Taipei (TW)

Correspondence Address: MERCHANT & GOULD PC, P.O. BOX 2903, MINNEAPOLIS, MN, 55402-0903, US

(73) Assignee: TEAM WORLDWIDE CORP., Taipei (TW)

(21) Appl. No.: 11/930,679

(22) Filed: Oct. 31, 2007

Related U.S. Application Data
(63) Continuation-in-part of application No. 10/916,696, filed on Aug. 12, 2004, now Pat. No. 7,306,694.
Application No. 10/916,696 is a division of application No. 09/999,341, filed on Nov. 29, 2001, now Pat. No. 6,800,165.
Application No. 09/999,341 is a continuation-in-part of application No. 09/432,446, filed on Nov. 2, 1999, now abandoned.

(51) Int. Cl. B29C 65/02

(52) U.S. Cl. 156/219; 156/299

(57) ABSTRACT

An envelope is made by at least heat sealing two face sheets. Each face sheet has thick marginal parts and spaced apart thick connection parts. The envelope has at least one heat-sealed peripheral joint, and a plurality of spaced apart heat-sealed seams. The heat-sealed seams are provided on the thick connection parts, and the heat-sealed peripheral joint is provided on the thick marginal parts. The thick connection parts have spaced apart longitudinal strips, and at least one transverse strip extending transversely of the longitudinal strips and interconnecting at least two of the longitudinal strips.

### CROSS REFERENCE TO RELATED APPLICATION

This application is a Continuation-In-Part of U.S. patent application Ser. No. 10/916,696 which was filed on Aug. 12, 2004 and which is a division of U.S. patent application Ser. No. 09/999,341, now U.S. Pat. No. 6,800,165. U.S. patent application Ser. No. 09/999,341 was filed on Nov. 29, 2001, and is a Continuation-In-Part of U.S. patent application Ser. No. 09/432,446 which was filed on Nov. 2, 1999 and was abandoned.

### BACKGROUND OF THE INVENTION

1. Field of the Invention

The invention relates to a method for making plastic products, more particularly to a method for making plastic products which comprises improvements with respect to the heat-sealing of the plastic products.

2. Description of the Related Art

Conventionally, plastic products, such as inflatable cushions, air beds, floats, etc., are fabricated by welding or heat sealing a plurality of plastic sheets to form fluid-tight envelopes. Welded or heat sealed joints are therefore formed in the plastic products. Since the thickness of the plastic sheets is reduced at the heat-sealed joints, the structural strength of the plastic products is relatively weak at the heat-sealed joints so that the plastic products are liable to damage when inflated. A solution to such a problem in the prior art is to use thick plastic sheets in fabricating such products. However, this increases manufacturing costs.

### SUMMARY OF THE INVENTION

An object of the present invention is to provide a method for making a plastic product of the above-mentioned type that is inexpensive and that has reinforced heat-sealed seams.

According to the present invention, a method for making a plastic product comprises providing two face sheets each of which has marginal ends, a plurality of thick marginal parts respectively formed at the marginal ends, and a plurality of spaced apart thick connection parts formed within a region confined by the marginal ends. The thick connection parts and marginal parts are thicker than remaining regions of a respective one of the face sheets. The method further comprises forming an envelope by at least heat sealing the face sheets. The envelope has at least one heat-sealed peripheral joint, and a plurality of spaced apart heat-sealed seams formed on the envelope within an area surrounded by the heat-sealed peripheral joint. The heat-sealed seams are provided on the thick connection parts, and the heat-sealed peripheral joint is provided on the thick marginal parts. The thick connection parts include spaced apart longitudinal strips, and at least one transverse strip extending transversely of the longitudinal strips and interconnecting at least two of the longitudinal strips.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded view showing a preferred embodiment of the invention disclosed in the basic U.S. patent application Ser. No. 10/916,696;

FIG. 2 is a perspective view showing a sheet material used in the invention disclosed in the basic U.S. patent application;

FIG. 3 is a perspective view showing another sheet material used in the invention disclosed in the basic U.S. patent application;

FIG. 4 is a perspective view of an envelope made by the method of the present invention;

FIG. 5 is a plan view showing a face sheet used in the method; and

FIG. 6 is a plan view showing an alternative face sheet used in the method.

### DETAILED DESCRIPTION OF THE PREFERRED EMBODIMENTS

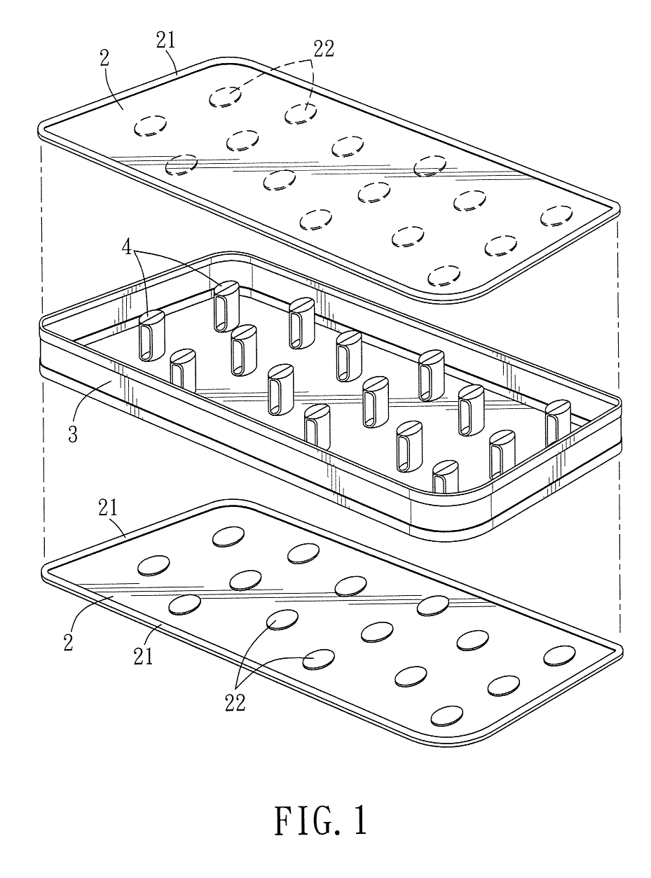

U.S. patent application Ser. No. 10/916,696, which is the basic application discloses a method of making a plastic product by heat sealing one or more plastic sheets to form an envelope. In order to strengthen the heat-sealed joints of the plastic sheets, the plastic sheets are thickened at portions where the heat-sealed joints are to be formed. FIG. 1 shows a preferred embodiment in the basic application in which an envelope is fabricated using upper and lower plastic sheets 2, a lateral plastic sheet 3 and a plurality of tension members 4. Each of the upper and lower sheets 2 has thick marginal parts 21 extending at four sides thereof, and a plurality of spaced apart thick connection parts 22 formed within the region confined by the thick marginal parts 21. The tension members 4 are provided between the upper and lower face sheets 2 and are respectively heat-sealed to the thick connection parts 22 of the upper and lower sheets 2.

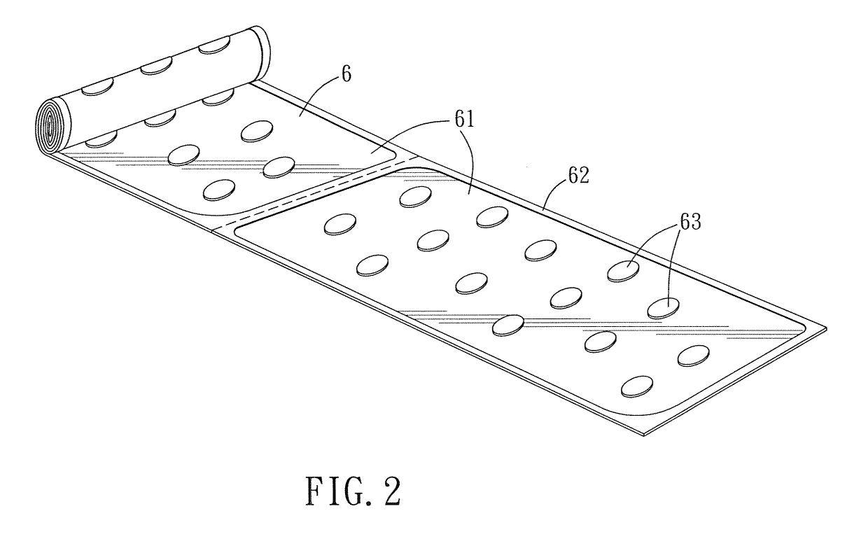

FIG. 2 shows a roll of sheet material 6 used in the preferred embodiment of the basic application to provide the upper and lower sheets 2. The sheet material 6 has a plurality of sections 61 which can be separated by cutting and which are used as the upper and lower sheets 2. Raised patterns 62, 63 are formed on the sheet material 6 through an embossing process and are used as the thick marginal parts 21 and the thick connection parts 22. The embossed thick connection parts 22 are circular in cross section and are spaced apart from each other, as shown in FIG. 1.

FIG. 3 shows another sheet material 7 used in another preferred embodiment of the basic application. The sheet material 7 is provided with a plurality of spaced apart embossed thick connection parts 71. The thick connection parts 71 are spaced apart from each other and extend along parallel lines.

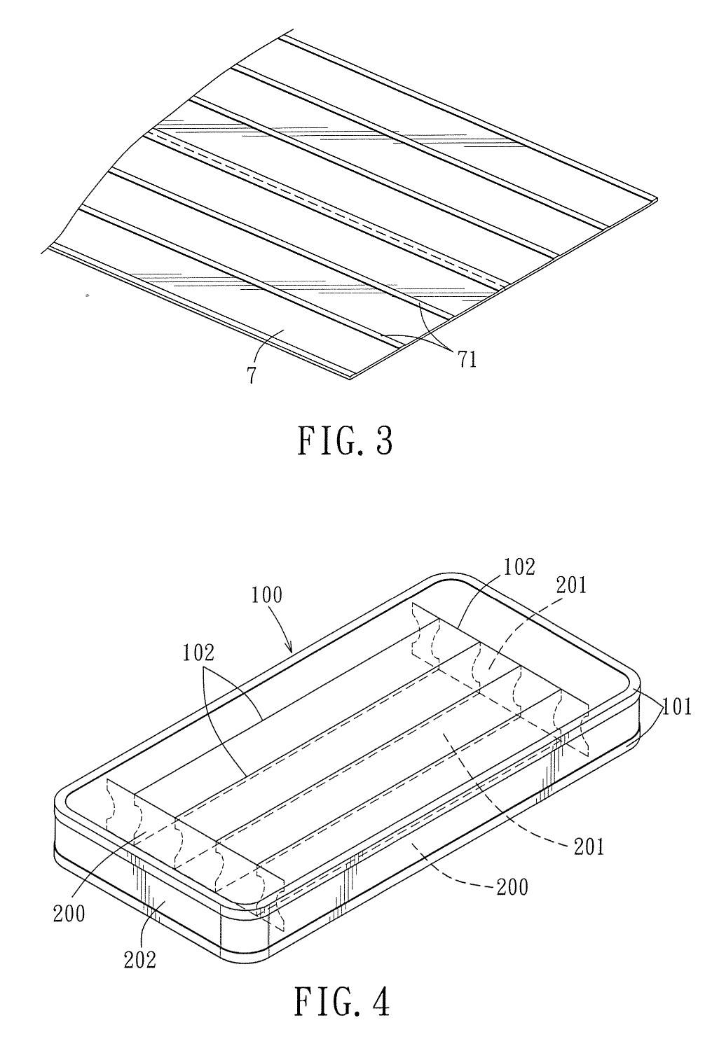

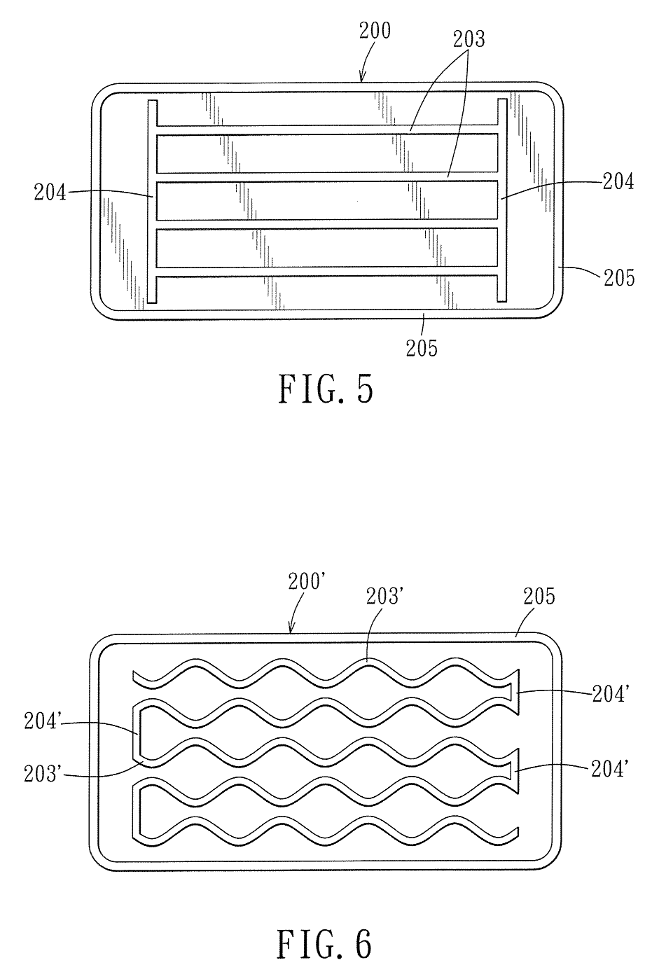

Referring to FIGS. 4 and 5, there is shown an envelope 100 made by the method of the present invention. The envelope 100 is configured as an air mattress, and has upper and lower heat-sealed peripheral joints 101, and a plurality of upper and lower heat-sealed seams 102 (only upper heat-sealed seams 102 are visible) formed on the envelope 100 within an area surrounded by the heat-sealed peripheral joints 101.

To form the envelope 100, the method is conducted by assembling two heat sealable upper and lower face sheets 200, a plurality of heat sealable tension members 201, and a heat sealable lateral sheet 202. Each face sheet 200 has a plurality of thick connection parts 203, 204, and a plurality of thick marginal parts 205. The thick connection parts 203, 204 and the thick marginal parts 205 are thicker than remaining regions of the face sheet 200. The heat-sealed seams 102 are provided on the thick connection parts 203, 204, whereas the heat-sealed peripheral joints 101 are provided on the thick marginal parts 205.

Specifically, the thick connection parts 203, 204 include spaced apart longitudinal strips 203, and transverse strips 204 extending transversely of the longitudinal strips 203. Each transverse strip 204 is connected to one end of each longitudinal strip 203. Preferably, the thick connection parts 203, 204 and the thick marginal parts 205 are provided by means of an embossing process.

The tension members 201 are provided between the face sheets 200, and two ends of each tension member 201 are respectively heat sealed to the upper and lower face sheets 200 at the respective thick connection parts 203, 204, thereby forming the upper and lower heat-sealed seams 102. The lateral sheet 202 is heat-sealed to the upper and lower face sheets 200 at the respective thick marginal parts 205, thereby forming the upper and lower heat-sealed peripheral joints 101. The heat-sealed seams 102 are reinforced as they are provided on the thick connections parts 203, 204. Similarly, the heat-sealed peripheral joints 101 are reinforced as they are provided on the thick marginal parts 205.

Alternatively, the upper and lower face sheets 200 may be heat sealed to each other to form an envelope without using the tension members 201 and the lateral sheet 202.

Referring to FIG. 6, the upper and lower face sheets 200 may be replaced by the upper and lower face sheets 200′. Each of the upper and lower face sheets 200′ has longitudinal strips 203′ and transverse strips 204′. The transverse strips 204′ are disposed alternately on two sides of the longitudinal strips 203′. Each transverse strip 204′ is connected to two adjacent ends of two adjacent longitudinal strips 203′.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A method for making a plastic product comprising:
providing two face sheets each having marginal ends, a plurality of thick marginal parts respectively formed at said marginal ends, and a plurality of spaced apart thick connection parts formed within a region confined by said marginal ends, said thick connection parts and marginal parts being thicker than remaining regions of a respective one of said face sheets; and
forming an envelope by at least heat sealing said face sheets, said envelope having at least one heat-sealed peripheral joint, and a plurality of spaced apart heat-sealed seams formed on said envelope within an area surrounded by said heat-sealed peripheral joint, said heat-sealed seams being provided on said thick connection parts, said heat-sealed peripheral joint being provided on said thick marginal parts;
said thick connection parts including spaced apart longitudinal strips, and at least one transverse strip extending transversely of said longitudinal strips and interconnecting at least two of said longitudinal strips.

2. The method of claim 1, wherein said thick connection parts and said thick marginal parts are formed by an embossing process.

3. The method of claim 1, wherein said transverse strip is connected to one end of each of said longitudinal strips.

4. The method of claim 1, wherein said thick connection parts include a plurality of said transverse strips each connected between two adjacent ones of said longitudinal strips.

5. The method of claim 1, further comprising a plurality of tension members which are disposed between said face sheets and each of which has two ends respectively heat sealed to said face sheets at respective ones of said thick connection parts.
